(19) United States
(12) Patent Application Publication
(10) Pub. No.: US 2012/0189074 A1
(43) Pub. Date: Jul. 26, 2012

(54) Diversity for Digital Distributed Antenna Systems

(75) Inventors: Hang Jin, Plano, TX (US); Rajesh Pazhyannur, Milpitas, CA (US); Fred Jay Anderson, Lakeville, OH (US)

(73) Assignee: CISCO TECHNOLOGY, INC., San Jose, CA (US)

(21) Appl. No.: 13/011,425

(22) Filed: Jan. 21, 2011

(51) Int. Cl. H04B 7/26; H04B 7/02

(52) U.S. Cl. 375/267; 455/507

(57) ABSTRACT

Techniques are provided for a base station to transmit and receive wireless signals via a plurality of remote transceiver stations deployed in a coverage area. The remote transceiver stations are coupled to the base station in order to communicate with wireless mobile devices. A transmission time delay is determined for a message to be transmitted from corresponding remote transceiver stations to a wireless mobile device. Transmission of the message to be wirelessly transmitted from the two or more remote transceiver stations is delayed by a corresponding transmission time delay. The delayed transmissions appear as a resolvable multipath transmission to receivers in the wireless mobile user devices. Techniques are also provided for delaying the processing of uplink transmissions at the base station receiver. Delays associated with downlink or uplink transmissions may also be programmed into individual remote transceiver stations.

### TECHNICAL FIELD

The present disclosure generally relates to digital distributed antenna systems.

### BACKGROUND

Distributed antenna systems have been used to provide indoor cellular coverage. A digital distributed antenna system has become a deployment option for new or upgraded systems due to the lower cost and ease of deployment. A digital distributed antenna system consists of a centralized radio source, e.g., a base station, and multiple remote radio transceivers called “remote radio heads.” The multiple remote radio heads connect to the centralized radio source over a packet based network, e.g., a local area network.

As an example for downlink signals, i.e., transmissions from the base station to the remote radio heads, the signal from the base station is digitized and converted into Ethernet packets to form digital baseband packets. The packets are broadcast to the multiple remote radio heads over the local area network. At the remote radio heads, the digital signal is then converted to an analog signal and transmitted over the air to a mobile subscriber. Similarly, for uplink signals received at the remote radio heads from a mobile subscriber and sent from the remote radio heads to the base station, the signals received at the remote radio heads from the mobile subscriber are digitized and packetized, and then sent to the base station over the local area network.

As one base station may connect to multiple remote radio heads, the uplink signals from the multiple remote radio heads first need to be combined into a single data stream and then fed to the base station. An IEEE 1588 timing mechanism (or other network timing schemes) is implemented to synchronize the packets for downlink and uplink transmissions. For the downlink, the base station broadcasts the downlink to all the remote radio heads. IEEE 1588 time stamps are added to the downlink packets to ensure that the same packet is transmitted over the air from all the remote radio heads at the same time. Similarly, IEEE 1588 time stamps are added to the uplink packets to ensure that the signal received on multiple remote radio heads arrive at a combiner coupled to the base station at the same time. The uplink signals are summed at the combiner in the digital domain.

### BRIEF DESCRIPTION OF THE DRAWINGS

FIG. 1 is an example block diagram of a network comprising base station and remote radio head devices that are configured to employ a delay diversity scheme according to the techniques described herein.

FIG. 2 is an example floor plan for a building with pre-positioned base station and remote radio head devices that are configured to employ a delay diversity scheme according to the techniques described herein.

FIG. 3 shows example timing diagrams that depict the effect of delay diversity for detecting signals received by a receiver.

FIG. 4 depicts example radiation patterns that have dead zones that can be reduced or eliminated using delay diversity.

FIG. 5 shows the example floor plan from FIG. 2 with the remote radio heads grouped into clusters that allow delay period reuse.

FIG. 6 depicts example radiation patterns for a cluster that employs delay diversity.

FIG. 7 is an example of a block diagram of a base station that is configured to employ delay diversity for uplink and downlink transmissions.

FIGS. 8a, 8b, 8c, 8d, and 8e depict a flowchart of a process for employing delay diversity at a base station.

FIG. 9 is an example of a block diagram of a radio transceiver that can serve as a remote radio head and is configured to employ delay diversity for uplink and downlink transmissions.

FIGS. 10a, 10b and 10c depict a flowchart of a process for employing delay diversity at a remote radio head.

### DESCRIPTION OF EXAMPLE EMBODIMENTS

### Overview

A base station is provided that is configured to be coupled to a plurality of remote transceiver stations deployed in a coverage area and which wirelessly transmit signals to and receive signals from wireless mobile devices. Transmission time delays are determined for a message to be transmitted from corresponding remote transceiver stations to a wireless mobile device. Transmission of the message from the two or more remote transceiver stations is delayed by the corresponding transmission time delays. The delayed transmissions appear as a resolvable multipath transmission to receivers in the wireless mobile user devices. Techniques are also provided for delaying the receive processing of uplink transmissions at the base station. Delays associated with downlink or uplink transmissions may also be programmed into individual remote transceiver stations.

### Example Embodiments

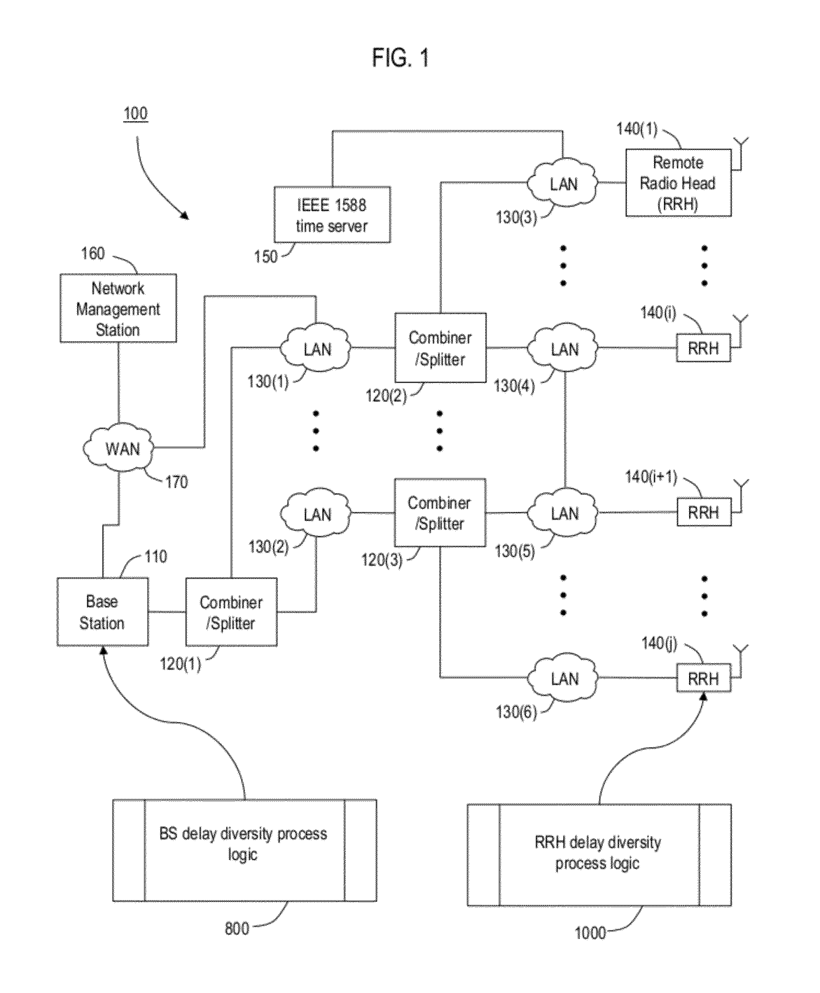

Referring first to FIG. 1, an example system 100 is shown comprising a base station and a plurality of remote radio transceivers, also called “remote radio heads” that communicate over a local area network and are configured to employ a delay diversity scheme. The system 100 comprises a base station (BS) 110, a plurality of remote radio heads (RRHs) 140(1)-140(j), an IEEE 1588 time server 150, a Network Management Station (NMS) 160, and a Wide Area Network (WAN) 170. The BS 110 and the RRHs 140(1)-140(j) communicate with each other over one or more local area networks (LANs) 130(1)-130(6) via combiner-splitters 120(1)-120(3). The combiner-splitters 120(1)-120(3) may be configured to combine/distribute signals from multiple RRHs and BSs at digital baseband. The various connections between the BS 110 and the RRHs 140(1)-140(j) may be made by wired means, e.g., coaxial or fiber optic cable, or by wireless means, e.g., over a WiFi™, WiMAX™ or other wireless communication system. While FIG. 1 shows a single BS 110 it should be understand that there are multiple BSs in a system deployment but a single BS 110 is shown for simplicity.

The base station 110 is configured with BS delay diversity process logic 800 while each of the RRHs may be configured with RRH delay diversity process logic 1000. Other network elements may be employed in system 100, e.g., routers, public switched telephone network connections, service provider gateways, Internet connections, or other base stations or wireless access points. System 100 may be used to extend wireless communication coverage in areas that may not be easily serviced by traditional cellular base stations, e.g., malls, subways, or buildings that have interference or otherwise block Radio Frequency (RF) signals.

For downlink traffic, the BS 110 receives traffic destined for wireless mobile devices, and distributes the traffic in packet form via LANs 130(1)-130(6) and combiner-splitters 120(1)-120(3) to two or more of the RRHs 140(1)-140(j) for wireless transmission. The combiner-splitters 120(1)-120(3) combine downlink signals from two or more base stations for transmission to the RRHs 140(1)-140(j) and split uplink signals between to two or more base stations, e.g., more than one base station may operate using system 100 with each base station employing a different air-interface protocol. Each packet from the BS 110 is transmitted over all of the RRHs 140(1)-140(j) because the location of wireless mobile devices is generally unknown to the BS 110, although this may not always be the case depending of the sophistication of system 100. For uplink traffic, the BS 110 receives uplink traffic via similar mechanisms with the combiner-splitters 120(1)-120(3) acting as traffic aggregators for the BS 110. Depending on wireless mobile device location, not all of the RRHs 140(1)-140(j) will receive uplink transmissions from a wireless mobile device and have packets to send to the BS 110.

For downlink transmissions from the BS 110 to two or more of the RRHs 140(1)-140(j) and ultimately to a wireless mobile device, the signal from the BS 110 is digitized and converted into Ethernet packets to form digital baseband packets. The packets are broadcast to the multiple RRHs over the local area networks. At the RRH, the digital signal is then converted to an analog signal and transmitted over the air to a wireless mobile device, e.g., mobile subscriber station. Similarly, for uplink signals received at the RRHs from a mobile subscriber and sent from the RRHs to the base station 110, the signals received at the remote radio heads from the mobile subscriber are digitized and packetized, and then sent to the base station 110 over the local area networks.

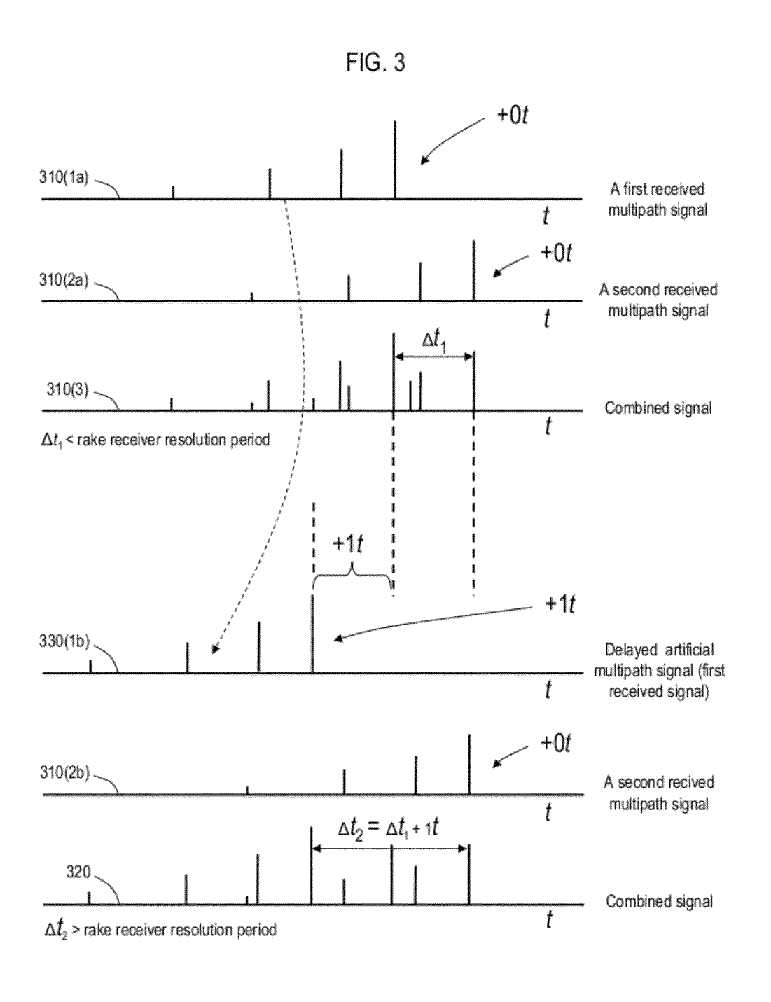

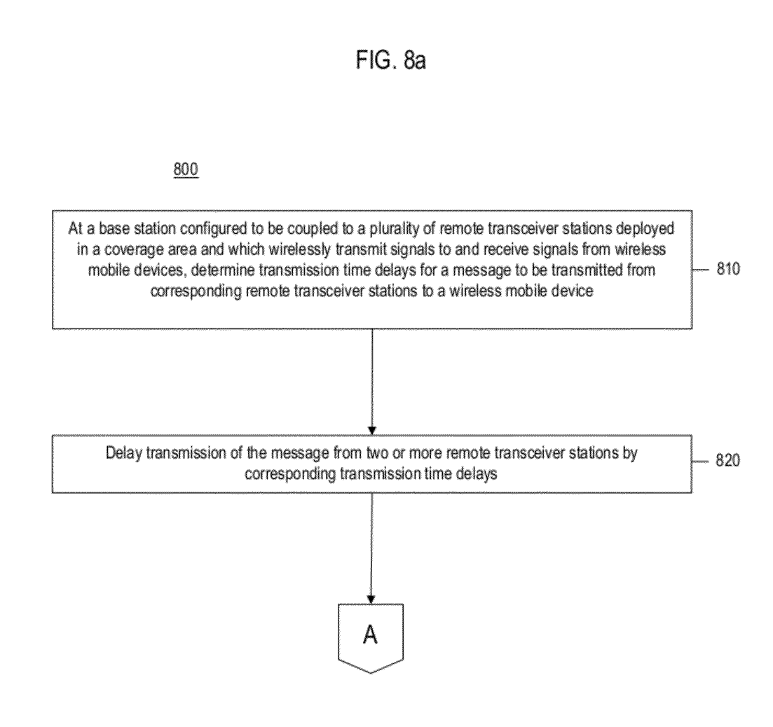

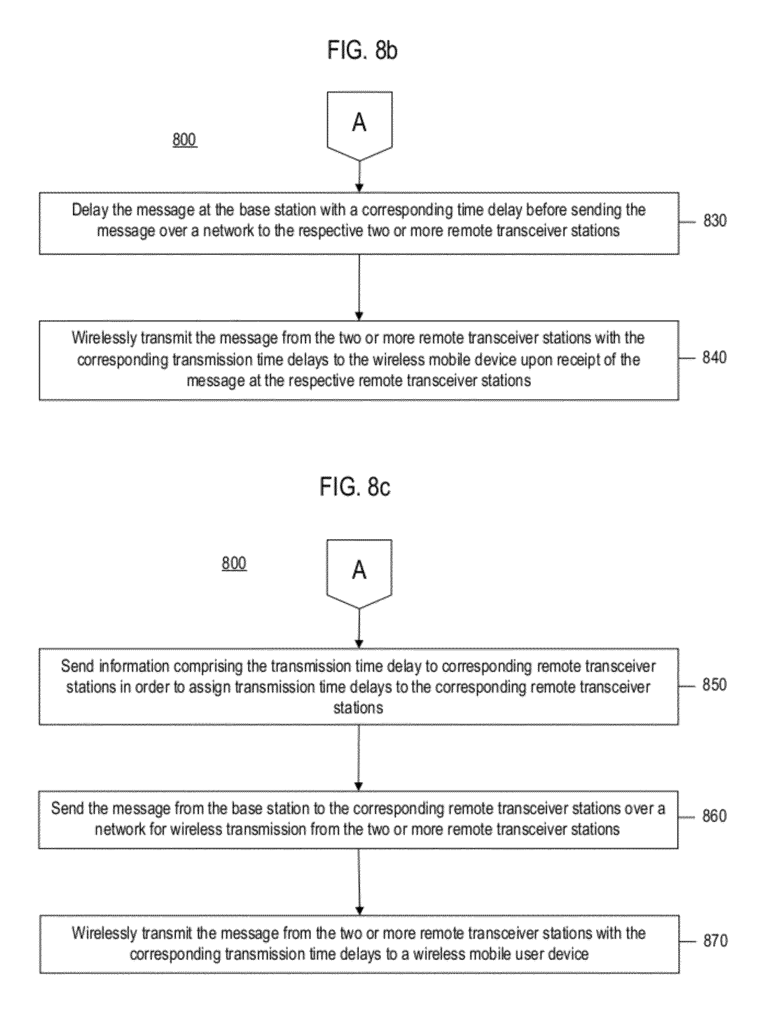

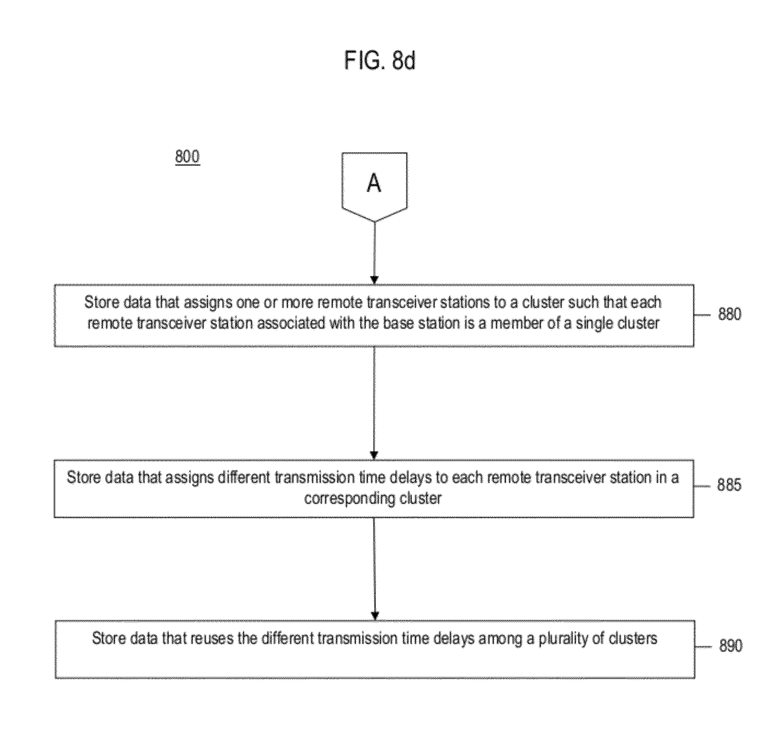

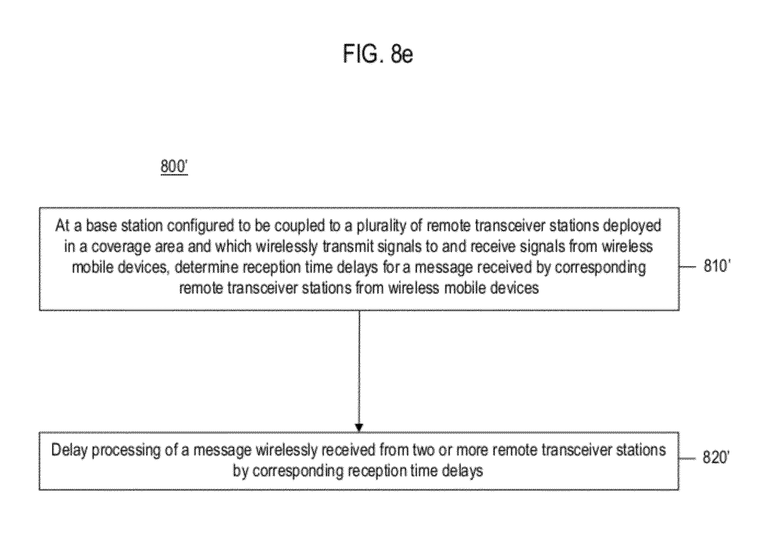

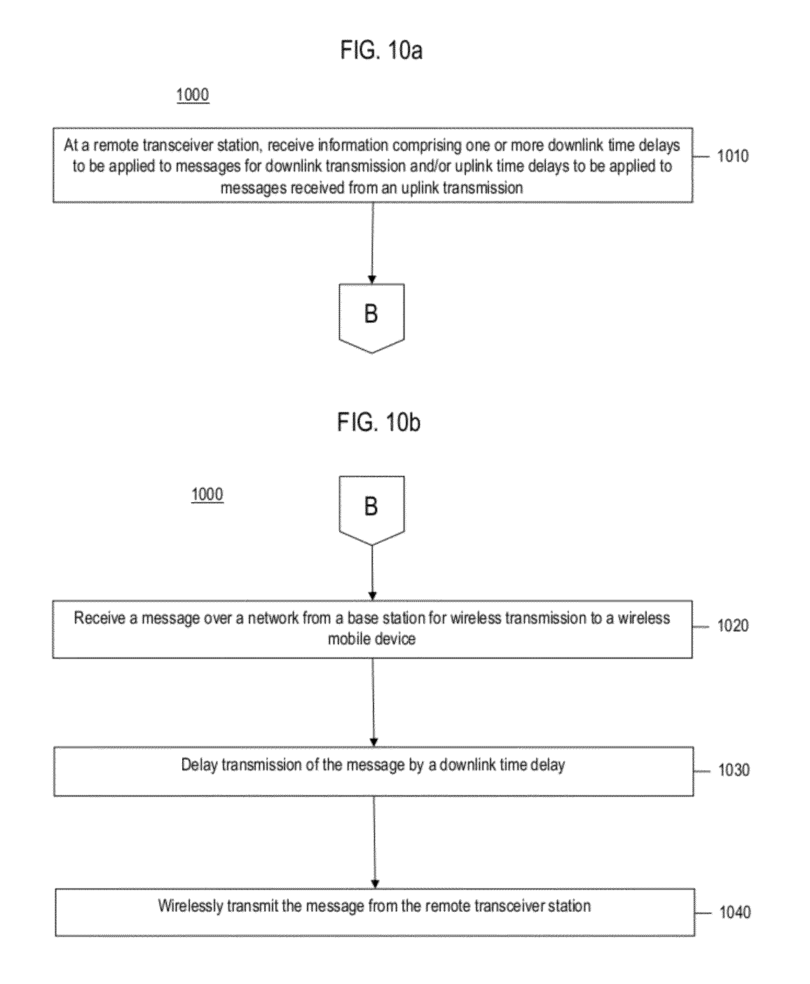

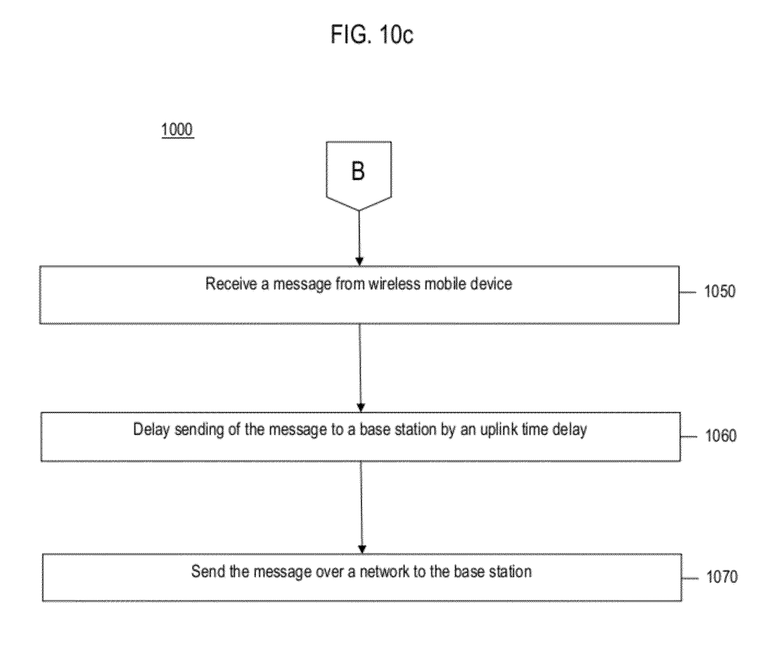

In general, the process logic 800 and process logic 1000 delays downlink radio frequency (RF) wireless transmissions of a given message (e.g., packet or frame) to a wireless mobile device using a different transmit delay or delay delta for each of the RRHs 140(1)-140(j). Thus, the same message is wirelessly transmitted by each of a plurality of RRHs with a corresponding different transmit delay for each RRH. When the wireless mobile device receives the multiple delayed transmissions of the same message, it appears to the wireless mobile device as a multipath reception of the message. In essence, an artificial multipath delay is introduced by the delayed transmissions. Similar delays in reception and/or processing of signals received from a mobile device can be introduced in order generate an artificial multipath for the receiver in the BS 110. The BS delay diversity process logic 800 will be generally described in connection with FIGS. 3, 4, 6, and 7, and will be described in greater detail in connection with FIGS. 8a-8d. The RRH delay diversity process logic 1000 will be generally described in connection with FIGS. 3, 4, 6, and 9, and will be described in greater detail in connection with FIG. 10. The delays used by the BS 110 or the RRHs 140(1)-140(j) may be assigned or programmed by the NMS 160 via WAN 170, or assigned or programmed by the BS 110.

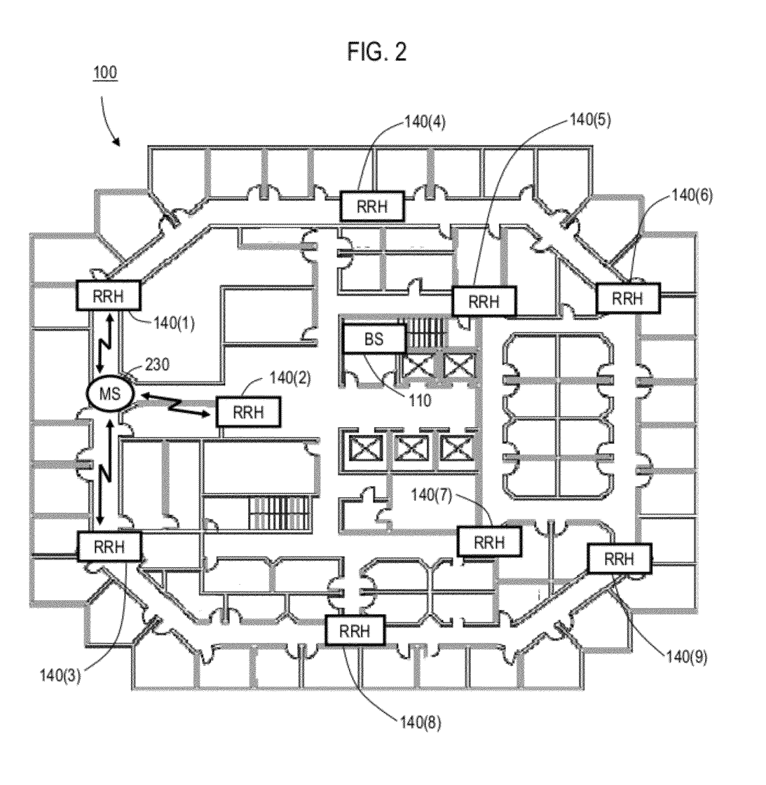

Referring to FIG. 2, an example deployment of the system 100 is shown. FIG. 2 shows an indoor deployment shown against an example floor plan, e.g., a mall with shops or a hotel floor with rooms. In this example system deployment, there is a plurality of RRHs 140(1)-140(9) and a single wireless mobile device or station (MS) 230. The MS 230 is shown in communication with RRHs 140(1), 140(2), and 140(3), as indicated by the double arrow lines. The MS 230 may also communicate with other RRHs in the system 100. The BS 110 processes messages to be transmitted to MS 230 and received from MS 230. Although system 100 is shown as an indoor deployment, certain geographic topologies or other considerations may warrant an outdoor deployment for system 100, e.g., to expand coverage in a remote geographic location.

Due to the nature of the communications solution provided by system 100, the RRHs, may be in close proximity to one another. This close proximity inherently introduces short transmission times between mobile devices and RRHs, when compared to the transmission times and multipath delays experienced in traditional outdoor cellular systems. The BS delay diversity process logic 800 and the RRH delay diversity process logic 1000 introduce delays such that base station and mobile device receivers can operate according to their original designs even when there the RRHs are in close proximity to each other.

Turning now to FIG. 3, example timing diagrams are shown that depict the effect of delay diversity on signals received by a receiver, e.g., a rake receiver. The receiver may be in a base station or in a mobile station. The three plots in the upper portion of FIG. 3 show signals for a receiver in a system that does not deploy delay diversity according to the techniques described herein. At 310(1a), an example signal is received by a receiver, e.g., a BS or RRH receiver. Four multipath signal components are shown at 310(1a) with various magnitudes that are indicated by the length of the vertical lines representing each multipath signal component. At 310(2a), another signal is received by the receiver. The signal shown at 310(2a) has four similar multipath components. The similarity represented signals is for ease of illustration and does not necessarily represent actual signals received by a given receiver.

At 310(3), the combined or signal summed by the receiver is shown. In this example, the primary signal components are too closely spaced in time for the receiver to individually detect them. The received signals at 310(1a) and 310(2a) are essential indistinguishable from on another. In other words, the delay spread of the received signals is too small. To further illustrate this point, if the spacing between the RRHs is on the order of 20-40 meters, the delay spread is on the order of 60-120 nanoseconds (ns). In this situation, the delay spread is less than what would normally be detectable or resolvable by a receiver, i.e., Δt₁ is less that the receiver's resolvable delay spread. Consequently, the fading induced by the close spacing of the RRHs creates multipaths that are unresolvable by the receiver, i.e., signals 310(1a) and 310(2a) essentially become “smeared” with respect to each other, and therefore, degrades the performance of the receiver.

Referring now to the three plots in lower portion of FIG. 3, the effects of an artificially introduced delay or artificial multipath will be described. At 330(1), the signal from 310(1a) is shown as if it were delayed by either process logic 800 or 1000. At 310(2b), the signal received at 310(2a) is copied for ease of illustration. At 320, the signal combined from signals 330(1) and 310(2b) is shown. In this example, the signal at 330(1) was delayed by +1t before transmission, reception, or reception processing, where t is the minimum delay spread that is resolvable by the receiver. The resulting delay of the combined signal, Δt₂, shown at 320, creates multiple paths at the receiver that can be decoded or resolved by the receiver. Thus, FIG. 3 illustrates the advantage of artificially introducing delays to signals transmitted by multiple RRHs to a given wireless mobile device so that the receiver in the wireless mobile device can detect/resolve the signal received from each RRH.

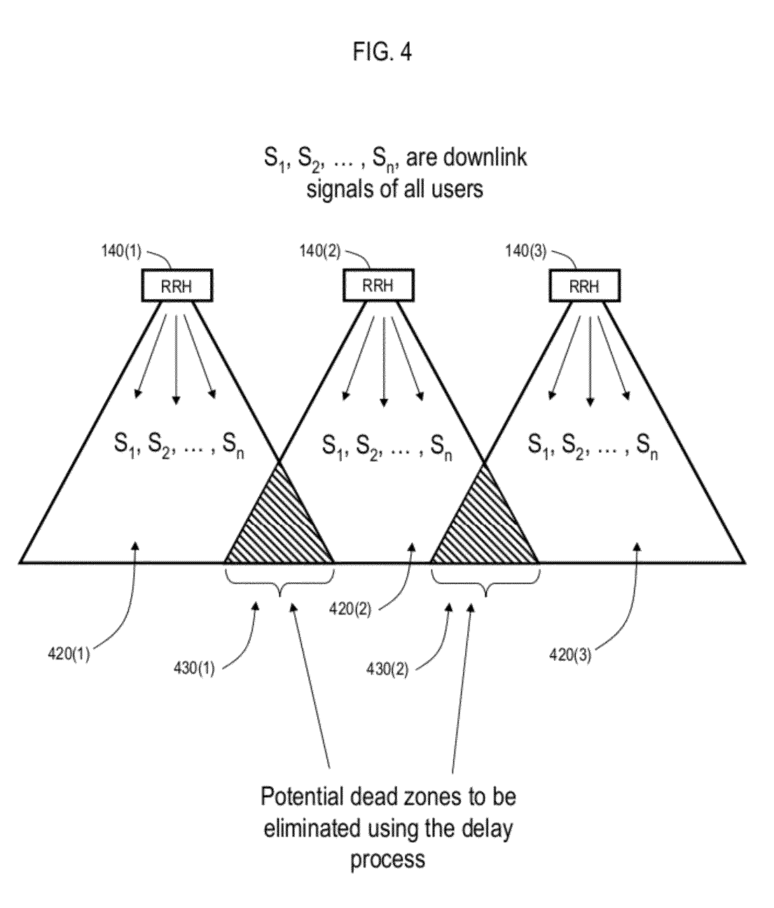

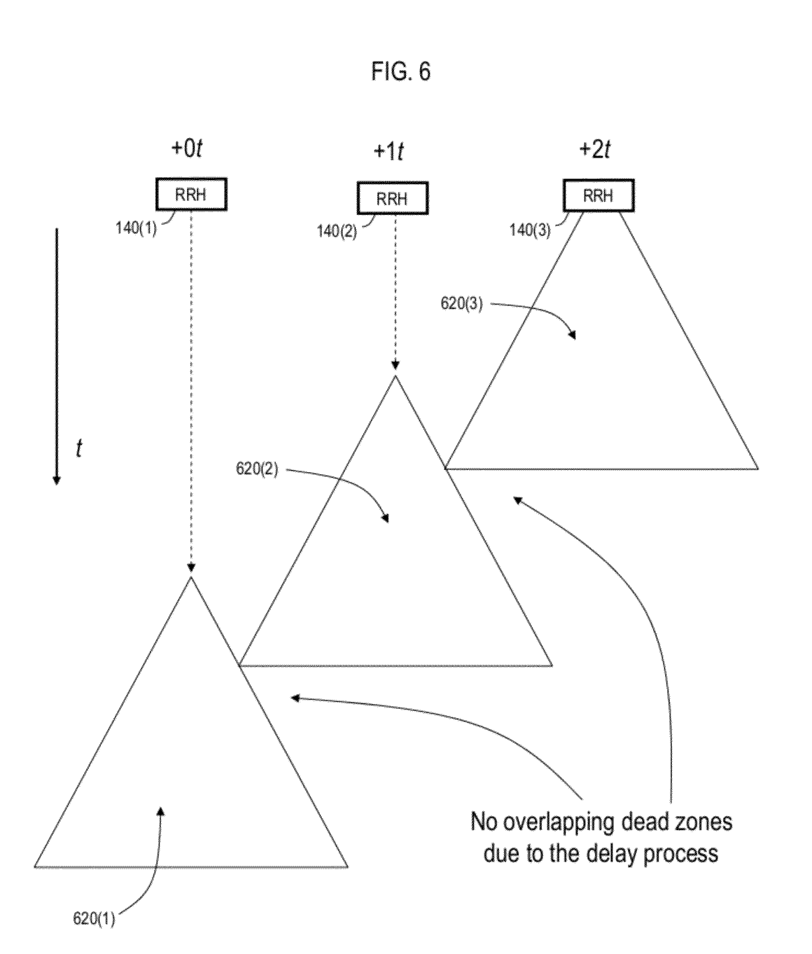

Referring now to FIG. 4, example radiation patterns that have dead zones that can be reduced or eliminated when using delay diversity process logic 800 will be described. Three RRHs 140(1)-140(3) are depicted in a horizontally linear arrangement from left to right. In this example, a message is received at each RRH 140(1)-140(3) from the base station for downlink transmission. The packets for the message have been time stamped for transmission from the RRHs 140(1)-410(3) at the same time and transmitted as signals S₁-Sₙ. As the multiple copies of the same signals S₁-Sₙ, propagate in regions 420(1)-420(3) they will constructively or destructively interfere with each other by virtue of their phases and magnitudes. The interference is particularly notable where the signals overlap and form potential “dead zones” 430(1) and 430(2). Dead zones 430(1) and 430(2) are regions where the downlink signals are destructively combined, and thus it is difficult for the downlink signals to be detected at the receiver in a MS when the MS is in a dead zone. The same effect also occurs for uplink transmissions combined at the base station. Operations of the BS delay diversity process logic 800 for reducing or eliminating dead zones will be described hereinafter in connection with FIG. 6.

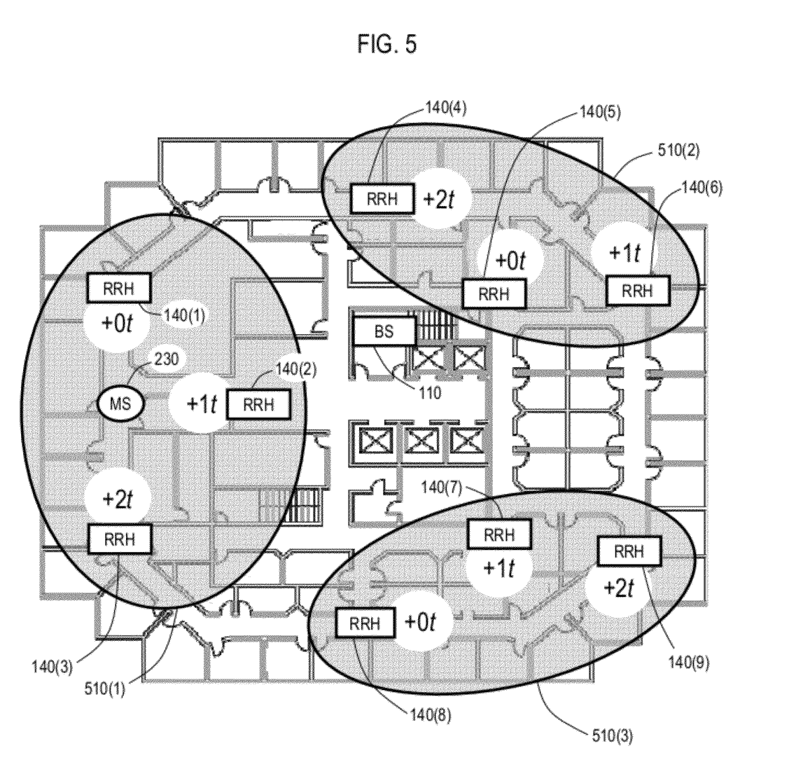

Referring now to FIG. 5, the example floor plan from FIG. 2 is shown with the RRHs grouped into clusters that allow delay reuse. In this example, three RRHs have been grouped into each of the clusters 510(1) through 510(3). Each of the RRHs in each cluster has been assigned or programmed with transmission time delays. In this example, the time delays are progressive from one RRH to the next, however, this is merely for illustration and other delays may be used. One of the RRHs in each cluster 510(1)-510(3) has been assigned a +0t transmission time delay which means that packets are converted and transmitted immediately. Another one of the RRHs in each cluster has been assigned a +1t transmission time delay which means that packets are converted and transmitted after a single delay time interval or time period. A third one of the RRHs in each cluster has been assigned a +2t transmission time delay which means that packets are converted and transmitted after two delay time intervals or time periods.

It is to be appreciated that the RRHs shown in FIG. 5 are clustered in groups of three to illustrate that the progressive transmission time delays may be reused among clusters. The assignment of RRHs in groups of three was arbitrary and each cluster could be assigned fewer or greater than three RRHs. Actual cluster assignments may be made according to system constraints such as cabling, electrical wiring, the air interface protocol in use, desired coverage area, among others. The delay differences or deltas described in connection with FIG. 5 are integer values of +0t, +1t, and +2t. The delay deltas do not have to be integer values, they do not have to be equally spaced, and they may be relative to each other, e.g., values of 0.5t, 1.8t, and 3.14t could be used, as long as the delay difference between adjacent RRHs is equal to or greater than t.

Referring now to FIG. 6 with continued reference to FIG. 4, example radiation patterns for a cluster that employs delay diversity is shown. The cluster has three RRHs 140(1)-140(3) that are shown in the same horizontally linear configuration as the RRHs shown in FIG. 4. Time is depicted on the vertical axis. The RRHs 140(1)-140(3) have been assigned delay deltas of +0t, +1t, and +2t, respectively.

In this example, the same message has been sent to all three RRHs 140(1)-140(3) for downlink transmission. At RRH 140(1), the message is transmitted without delay and the associated RF signals are shown at 620(1) further along in time. At RRH 140(2), the transmission was delayed by +1t and as shown at 620(2) and the RF signals are less further along in time than signals 620(1). At RRH 140(3), transmission of the message was delayed by +2t as shown at 620(3). By delaying the transmissions from the respective RRHs, the signals do not constructively or destructively interfere with each other, and dead zones, e.g., dead zones 430(1) and 430(2) shown in FIG. 4, are effectively reduced or eliminated.

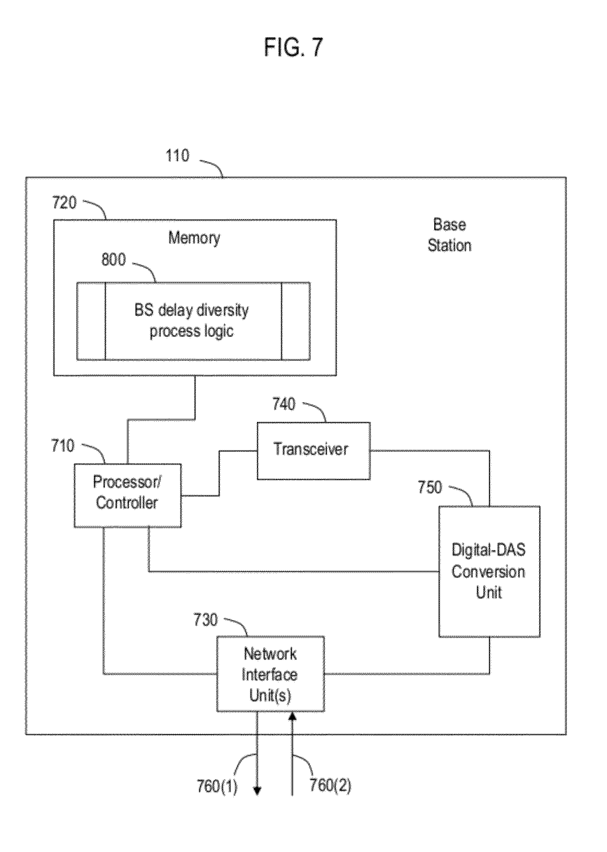

Reference is now made to FIG. 7 for a description of a wireless communication device, e.g., BS 110, that is configured or equipped to perform the aforementioned BS delay diversity process logic 800 for delaying downlink transmissions. The BS 110 comprises a transceiver 740, one or more network interfaces or units 730, and a processor or controller 710. The controller 710 supplies data (in the form of transmit signals) to the transceiver 740 to be transmitted and processes signals received by the transceiver 740. In addition, the controller 710 performs other transmit and receive control functionality. Parts of the functions of the transceiver 740 and controller 710 may be implemented in a modem and other parts of the transceiver 740 may be implemented in radio transmitter and radio receiver circuits. It should be understood that there are analog-to-digital converters (ADCs) and digital-to-analog converters (DACs) in the various signal paths to convert between analog and digital signals. The network interface units 730 are configured to provide an interface to a telephone system and/or a service provider network for bidirectional communication and to provide an interface to network devices, e.g., the combiner-splitters 120(1)-120(3) and LANs 130(1)-130(6) shown in FIG. 1 for downlink and uplink transmissions, and ultimately to the RRHs 140(1)-140(j). The network interface units 730 may also receive configuration commands, e.g., delay deltas, from a network management station, e.g., NMS 160 shown in FIG. 1.

Coupled to the transceiver 740 is a digital-distributed antenna system (DAS) conversion unit 750. The digital-DAS conversion unit 750 is configured to perform any physical layer conversions for transmitting downlink signals 760(1) and for receiving uplink signals 760(2). In this regard, the digital-DAS conversion unit 750 may be external to the base station 110 and coupled to the RF antenna ports of the base station 110, and acts as a network interface, e.g., to the network shown in FIG. 1. In this example, the digital-DAS conversion unit 750 receives downlink signals, e.g., RF signals, from the transceiver 740. The digital-DAS conversion unit 750 converts and digitizes the RF signal into baseband digital signals. The DAS conversion unit 750 packetizes the baseband digital signals, e.g., into IP packets for Ethernet transmission, via network interface units 730, over various local area networks, e.g., one of the local area networks 130(1)-130(6) shown in FIG. 1. In this example, packetized downlink signals are shown at 760(1). In other examples, the base station 110 does not use transceiver circuitry or antennas, and processes all traffic at baseband and the digital-DAS conversion unit 750 is not needed.

Similarly, another function of the network interface units 730 is to receive packetized uplink signals 760(2) from the RRHs that carry digital baseband uplink signals. The digital-DAS conversion unit 750 upconverts the received digital baseband uplink signals into inband RF signals for processing by the transceiver 740. The downlink 760(1) and uplink 760(2) packets have synchronization time stamps, e.g., IEEE 1588 or Network Time Protocol (NTP) time stamps, to synchronize RF transmissions as described above. In this regard, the BS delay diversity process logic 800 can use the timestamps to delay downlink RF transmissions at the RRHs. For uplink signals from mobile subscribers, process logic 800 can delay the processing of received signals to provide delay diversity. The process logic 800 executed by a base station, e.g. base station 110, has been generally described above and will be further described in connection with FIG. 8.

It is understood that the transceiver 740 may comprise a plurality of individual receiver circuits, each for a corresponding one of a plurality of antennas and which outputs a receive signal for downconversion processing by the transceiver 740 and then processing by the controller 710 for signal detection. A plurality of antennas may be used to achieve spatial diversity over the RF channels, or other desired characteristics. For simplicity, these individual receiver circuits are not shown. The transceiver 740 may comprise individual transmitter circuits that supply respective upconverted signals to corresponding ones of a plurality of antennas for transmission. For simplicity, these individual transmitter circuits are not shown. The controller 710 supplies the transmit signals to the transceiver 740 and the transceiver RF modulates (e.g., upconverts) the respective transmit signals for transmission via respective ones of the plurality of antennas. When a base station is configured to transmit and receive RF signals over plurality of antennas, the RRHs may have a corresponding number of antennas. In one example, packetized downlink and uplink signal streams may be directed to and received from individual antennas on the RRHs and processed accordingly to achieve downlink or uplink spatial diversity.

The controller 710 is, for example, a signal or data processor that comprises a memory device 720 or other data storage block that stores data used for the techniques described herein. The memory 720 may be separate or part of the controller 710. Instructions for the BS delay diversity process logic 800 are stored in the memory 720 for execution by the controller 710.

The functions of the controller 710 may be implemented by logic encoded in one or more tangible non-transitory media (e.g., embedded logic such as an application specific integrated circuit, digital signal processor instructions, software that is executed by a processor, etc.), wherein the memory 720 stores data used for the computations described herein and stores software or processor instructions that are executed to carry out the computations described herein. Thus, the process logic 800 may take any of a variety of forms, so as to be encoded in one or more computer readable tangible media (e.g., a memory device) for execution, such as with fixed logic or programmable logic (e.g., software/computer instructions executed by a processor) and the controller 710 may be a programmable processor, programmable digital logic (e.g., field programmable gate array) or an application specific integrated circuit (ASIC) that comprises fixed digital logic, or a combination thereof. For example, the controller 710 may be a modem in the base station and thus be embodied by digital logic gates in a fixed or programmable digital logic integrated circuit, which digital logic gates are configured to perform the process logic 800. In another form, the process logic 800 may be embodied in a processor readable medium that is encoded with instructions for execution by a processor (e.g., controller 710) that, when executed by the processor, are operable to cause the processor to perform the functions described herein in connection with process logic 800.

Referring now to FIGS. 8a-8d, an example flowchart is shown that generally depicts the operations of the BS delay diversity process logic 800 that delays individual transmissions transmitted from corresponding remote transceiver stations, e.g., RRHs 140(1)-140(j), according to a first example embodiment. Referring first to FIG. 8a, at 810, at a base station configured to be coupled to a plurality of remote transceiver stations deployed in a coverage area and which wirelessly transmit signals to and receive signals from wireless mobile devices, transmission time delays are determined for a message to be transmitted from corresponding remote transceiver stations to a wireless mobile device. At 820, transmission of the message from two or more remote transceiver stations is delayed by the corresponding transmission time delays. That is, the message is transmitted from each of the two or more remote radio transceivers with a different transmission delay. Example delay mechanisms for the base station and for the RRHs are described in connection with FIGS. 8b and 8c, respectively. A mechanism for assigning RRH clusters is described in connection with FIG. 8d.

Referring next to FIG. 8b, the process from FIG. 8a is continued according to an example delay mechanism for a base station. At 830, the message is delayed at the base station with a corresponding time delay before sending the message over a network to the respective two or more remote transceiver stations. At 840, the message is wirelessly transmitted from the two or more remote transceiver stations with the corresponding transmission time delays to the wireless mobile device upon receipt of the message at the respective remote transceiver stations. The message may also be delayed by the base station by encoding the transmission time delays in the message so that the message is transmitted at the delay time. In one example, the transmission delay time is added to an IEEE 1588 timestamp in the message in order to generate a delay at the RRH. The transmission time delays may be varied in response to one or more of: changing data traffic conditions, the number of mobile wireless user devices in the coverage area, wireless channel conditions, and expired timer for a mechanism configured to periodically vary of the transmission time delays, i.e., at a periodic time interval.

Referring to FIG. 8c, the process from FIG. 8a is continued according to an example delay mechanism for a remote transceiver station. At 850, information is sent that comprises (contains, represents or indicates) the transmission time delay to corresponding remote transceiver stations in order to assign a transmission time delay to the corresponding remote transceiver station. In this example, the RRH is essentially programmed with a time delay. All transmissions at respective RRHs are delayed by a corresponding transmission time delay. At 860, the message is sent from the base station to the corresponding remote transceiver stations over a network for wireless transmission from the two or more remote transceiver stations. At 870, the message is wirelessly transmitted from the two or more remote transceiver stations with the corresponding transmission time delays to a wireless mobile device, as described above.

In summary, FIGS. 8a, 8b, and 8c describe a base station that is configured to generate a message to be transmitted via the plurality of remote transceiver stations, apply corresponding transmission time delays to the message for wireless transmission by corresponding ones of the plurality of remote transceiver stations, and send the message to the plurality of remote transceiver stations over the network for wireless transmission by corresponding ones of the plurality of remote transceiver stations with the corresponding time delays. The transmission delays may be performed at the base station or at the remote transceiver stations.

Referring to FIG. 8d with additional reference to FIG. 5, the process from FIG. 8a is continued according to an example delay reuse mechanism for remote transceiver stations assigned to a cluster, as shown in FIG. 5. At 880, data is stored that assigns one or more remote transceiver stations to a cluster such that each remote transceiver station associated with the base station is a member of a single cluster. At 885, data is stored that assigns different transmission time delays to each remote transceiver station in a corresponding cluster. At 890, data is stored that reuses the different transmission time delays among a plurality of clusters.

The delays described above may be tuned for a particular air-interface. In one example, the transmission time delay is determined for downlink transmission of the message from the two or more the remote transceiver stations that result in a resolvable multipath solution for a receiver in a mobile wireless user device. In another example, the transmission time delay is determined that corresponds to a duration of an encoding sequence, e.g., a Pseudo-Noise (PN) code described below, that allows a receiver in the wireless mobile device to decode received transmissions that were delayed with transmission time delays. Similarly, transmission time delays may also be applied to uplink transmissions from the wireless mobile device to the base station that allows a receiver in the base station to resolve uplink multipath signals.

One example air-interface protocol is a Code Division Multiple Access (CDMA) protocol employed by a Universal Mobile Telecommunication System (UMTS). The UMTS base stations and mobile stations employ a rake receiver to resolve and decode multipath signals. The CDMA protocol encodes symbols or bits of data with chips that operate at a higher frequency than the underlying data. In this example the chips are derived using orthogonal codes, e.g., Walsh codes, and are referred to as PN codes. Rake receivers use the orthogonal codes to resolve multipath signals and detect the underlying data, e.g., voice, video, or data for other services. The rake receiver acts as an equalizer in that it tracks each multipath signal individually, and then coherently combines them, i.e., a rake receiver operates as if it were many sub-receivers, termed “fingers” of the rake, that each decode a multipath component. For each path, the channel is flat by design, i.e., the channel has one tap for each finger, such that the PN codes remain orthogonal.

In order for the rake receiver to operate, the multiple paths need be “resolvable”, that is, each path has to be distinguishable from each of the other paths. The UMTS protocol employs a 3.84 Mbps chip rate. To resolve or separate the multipath signals, each path's signal has to arrive at the rake receiver with a certain amount of delay. In this example, the delay should be greater that 260 nanoseconds corresponding to the reciprocal of the chip rate (1/3.84 mbps). For outdoor installations, e.g., macro-cell installations, the multipath delays do not pose a problem since the multipath signals may travel longer distances relative to multipath signals in indoor Digital-DAS installations.

The spacing among RRHs is in the range of 20 meters to 50 meters. When the same signal is transmitted from all RRHs at the same time, each signal in essence becomes an “artificial” multipath signal. In this regard, the 20-50 meter separation corresponds to an artificial multipath delay of approximately 60 to 150 nanoseconds, which is less than the UMTS chip duration of 260 nanoseconds. This relatively low delay may result in the received signals not being resolvable by the rake receiver in the intended destination device. In other words, the delay spread for the artificial multipaths is too small for the rake receiver. The techniques described herein deliberately add some delay in the transmitted signal from different RRHs such that the signals transmitted by the different RRHs are resolvable by a rake receiver.

The delay diversity scheme maintains the orthogonality of the PN codes, and improves the performance of the rake receiver. The delay diversity scheme makes the multipath signals appear to originate from a macro-cell environment, for which UMTS systems are optimized. As long as the delays from different RRH are kept within the search window of the rake receiver (2000 nanoseconds according to the UMTS specifications) the signal will appear normal to the intended destination device. In other air-interface protocols, e.g., Orthogonal Frequency-Division Multiplexing (OFDM)-based protocols as incorporated into the Long-Term Evolution and LTE-advanced standards, the delay diversity scheme may be adapted for use in a Cyclic Delay Diversity (CDD) type of scheme, used in WiFi and WiMAX systems.

The transmission delays used by each RRH may be assigned to RRHs positioned in close proximity yet still allow a rake receiver of the intended destination devices to capture the most or all of the multipaths, including the “artificial” multipaths resulting from transmissions from multiple RRHs and the actual multipath signals caused by environment reflections. For example, for UMTS, the delay delta is selected to be equal to the chip duration of 260 nanoseconds. To assign delay deltas, a first RRH is considered and the transmission delay to the combiner, e.g., combiner-splitter 120(1) of FIG. 1, is denoted x. One of the neighboring RRHs is then selected and a delay equal x+260 is assigned to it. A third RRH is then selected and it's the delay to equal x+(2×260) is assigned to it, and so on. Furthermore, for each RRH, the assigned downlink delay may differ from an assigned uplink delay. In some cases, it may be beneficial to have different downlink and uplink delays. For example, femto-cell base stations may have limited processing capability and the rake receiver search window is limited by design. In this case it may be better to minimize the uplink delay delta, while the downlink can be assigned larger delay deltas for greater delay diversity.

Turning now to FIG. 8e, an example flowchart is shown that generally depicts the receive operations of the BS delay diversity process logic 800, labeled 800′ in this figure, to delay processing of individual signals received from corresponding remote transceiver stations, e.g., RRHs 140(1)-140(j). By delaying processing of the individual receive signals, delay diversity is achieved for a receiver in the base station. At 810′, at a base station configured to be coupled to a plurality of remote transceiver stations deployed in a coverage area and which wirelessly transmit signals to and receive signals from wireless mobile devices, reception time delays are determined for a message received by corresponding remote transceiver stations from wireless mobile devices. At 820′, processing of a message from a wireless mobile device wirelessly received at two or more remote transceiver stations is delayed by the corresponding reception time delays. The reception time delays for the uplink transmissions are determined so as to result in a decodable multipath solution for the receiver in the base station.

The analog uplink transmissions for the message received at the two or more remote transceiver stations are converted into digital signals and encapsulated into packets for transmission to the base station over a network. In another example, the packets may be delayed at the two or more remote transceiver stations with the corresponding time delays before sending the packets to the base station. In a further example, the packets themselves are delayed at the base station with the corresponding time delays before further processing of the packets at the base station.

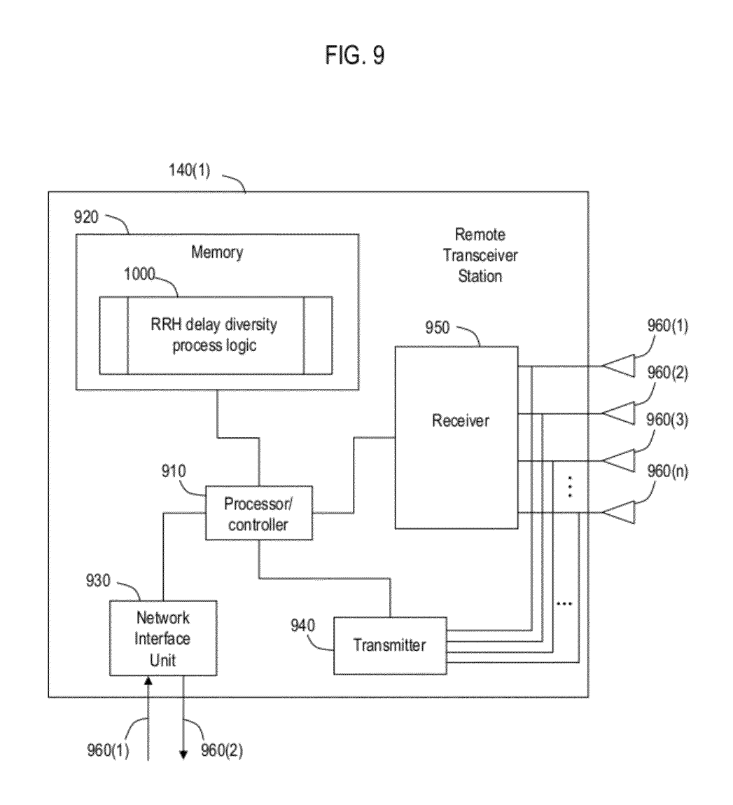

Reference is now made to FIG. 9, a remote transceiver station, e.g., RRH 140(1) from FIG. 1, is shown. RRH 140(1) may be equipped with RRH delay diversity process logic 1000. Process logic 1000 may be stored as software or implemented in hardware in any similar manner as process logic 800 described above for the base station 110. A flowchart for process logic 1000 is described hereinafter in connection with FIG. 10.

The RRH 140(1) comprises a network interface unit 930, a transmitter 940, a receiver 950, and a controller 910. The controller 910 supplies data (in the form of transmit signals) to the transmitter 940 to be transmitted and processes signals received by the receiver 950. In addition, the controller 910 performs other transmit and receive control functionality. Parts of the functions of the receiver 950, transmitter 940, and controller 910 may be implemented in a modem and other parts of the receiver 950 and transmitter 940 may be implemented in radio transmitter and radio transceiver circuits. It should be understood that there are analog-to-digital converters (ADCs) and digital-to-analog converters (DACs) in the various signal paths to convert between analog and digital signals.

The receiver 950 receives the signals from each of the antennas 960(1)-960(n) and supplies corresponding antenna-specific receive signals to the controller 910. It is understood that the receiver 950 may comprise a plurality of individual receiver circuits, each for a corresponding one of a plurality of antennas 960(1)-960(n), and which output a receive signal for downconversion processing by the receiver 950 and then processing by the controller 910 for signal detection and downlink beamforming weight vectors estimation. For simplicity, these individual receiver circuits are not shown. The transmitter 940 may comprise individual transmitter circuits that supply respective upconverted signals to corresponding ones of a plurality of antennas 960(1)-960(n) for transmission. For simplicity, these individual transmitter circuits are not shown. The controller 910 supplies the transmit signals to the transmitter 940 and the transmitter RF modulates (e.g., upconverts) the respective transmit signals for transmission via respective ones of the plurality of antennas.

The network interface unit 930 is configured to receive packetized downlink signals 960(1) and send packetized uplink signals 960(2). The packetized downlink signals 960(1) are decapsulated into digital baseband signals and processed by the controller 910 for RF upconversion and transmission by the transmitter 940 via the plurality of antennas 960(1)-960(n). Signals received at the plurality of antennas 960(1)-960(n) are RF downconverted into uplink digital baseband signals by the receiver 950 and controller 910. The downconverted uplink digital baseband signals are packetized and sent as packetized uplink digital baseband signals 960(2) by the network interface unit 930. The packetized downlink and uplink signals 960(1) and 920(2) are subsets of the packetized downlink and uplink signals 760(1) and 720(2) respectively, shown in FIG. 7, which are addressed by the base station 110 to RRH 140(1) (for downlink signals) and from RRH 140(1) (for uplink signals).

The controller 910 is, for example, a signal or data processor that comprises a memory device 920 or other data storage block that stores data used for the techniques described herein. The memory 920 may be separate or part of the controller 910. Instructions for RRH delay diversity process logic 1000 are stored in the memory 920 for execution by the controller 910. The process logic 1000 may apply delays to downlink or uplink transmissions using any of the techniques described above.

Referring to FIGS. 10a-10c, flowcharts generally depicting process logic 1000 for applying delay deltas to downlink and/or uplink transmissions will now be described. Referring first to FIG. 10a, at 1010, the process begins with a remote transceiver station receiving information that comprises one or more downlink time delays to be applied to messages for downlink transmission and/or uplink time delays to be applied to messages received from an uplink transmission. The process for delaying downlink transmissions is described in connection with FIG. 10b and process for delaying uplink transmissions is described in connection with FIG. 10c.

Turning to FIG. 10b, the process logic 1000 continues for delaying downlink transmissions. At 1020, a message is received over a network from a base station for wireless transmission to a wireless mobile device. At 1030, transmission of the message is delayed by a downlink time delay. At 1040, the message is wirelessly transmitted from the remote transceiver station to the wireless mobile device.

Turning to FIG. 10c, the process logic 1000 continues for delaying messages received from uplink transmissions. At 1050, a message is received from a wireless mobile device. At 1060, the message is delayed before being sent to the base station by an uplink time delay. The delay may also be achieved by adding delays to timestamps in message packets sent to the base station. At 1070, the message is sent from the remote transceiver station to the base station.

Techniques have been described herein for a base station to transmit and receive wireless signals via a plurality of remote transceiver stations deployed in a coverage area. The remote transceiver stations are coupled to the base station in order to communicate with wireless mobile devices. Transmission time delays are determined for a message to be transmitted from corresponding remote transceiver stations to a wireless mobile device. Transmission of the message from the two or more remote transceiver stations is delayed by the corresponding transmission time delays. The delayed transmissions appear as a resolvable multipath transmission to receivers in the wireless mobile devices.

Techniques are also provided for delaying the processing of uplink transmissions at the base station receiver. Delays associated with downlink or uplink transmissions may also be programmed into individual remote transceiver stations.

On the uplink side, the delay diversity techniques described herein help to ensure that the uplink signals received at adjacent RRHs will arrive at the combiner at different times and become resolvable multipaths for the rake receiver in the base station. Similarly, on the downlink side, the multiple copies of the downlink signal will arrive at the mobile station receiver at different times and appear as resolvable multipaths to the mobile station rake receiver. Thus, channel fading is reduced, receiver diversity is enhanced, and dead zones in the coverage are eliminated or substantially reduced.

The above description is intended by way of example only.

What is claimed is:

1. A method comprising:
at a base station configured to be coupled to a plurality of remote transceiver stations deployed in a coverage area and which wirelessly transmit signals to and receive signals from wireless mobile devices, determining transmission time delays for a message to be transmitted from corresponding remote transceiver stations to a wireless mobile device; and
delaying transmission of the message from two or more remote transceiver stations by the corresponding transmission time delays.

2. The method of claim 1, wherein delaying comprises delaying the message at the base station with corresponding time delays before sending the message over a network to the respective two or more remote transceiver stations and further comprising wirelessly transmitting the message from the two or more remote transceiver stations with the corresponding transmission time delays to the wireless mobile device upon receipt of the message at the respective remote transceiver stations.

3. The method of claim 1, further comprising:
sending information comprising the transmission time delays to corresponding remote transceiver stations in order to assign transmission time delays to the corresponding remote transceiver stations;
sending the message from the base station to the corresponding remote transceiver stations over a network for wireless transmission from the two or more remote transceiver stations; and
wirelessly transmitting the message from the two or more remote transceiver stations with the corresponding transmission time delays to a wireless mobile device based on the information comprising the transmission time delays.

4. The method of claim 1, wherein determining comprises determining the transmission time delays for downlink transmission of the message from the two or more the remote transceiver stations that result in a resolvable multipath solution for a receiver in a wireless mobile device.

5. The method of claim 1, wherein determining comprises determining the transmission time delays that corresponds to a duration of an encoding sequence that allows a receiver in the wireless mobile device to decode received transmissions that were delayed with the transmission time delays.

6. The method of claim 1, further comprising varying the transmission time delays periodically or in response to one or more of: changing data traffic conditions, the number of wireless mobile devices in the coverage area, and wireless channel conditions.

7. The method of claim 1, wherein delaying comprises encoding the transmission time delays in the message that is sent to the respective remote radio transceiver stations.

8. The method of claim 1, further comprising:
storing data that assigns one or more remote transceiver stations to a cluster such that each remote transceiver station associated with the base station is a member of a single cluster;
storing data that assigns different transmission time delays to each remote transceiver station in a corresponding cluster; and
storing data that reuses the different transmission time delays among a plurality of clusters.

9. A method comprising:
at a base station configured to be coupled to a plurality of remote transceiver stations deployed in a coverage area and which wirelessly transmit signals to and receive signals from wireless mobile devices, determining reception time delays for a message received by corresponding remote transceiver stations from wireless mobile devices; and
delaying processing of a message wirelessly received at two or more remote transceiver stations by corresponding reception time delays.

10. The method of claim 9, further comprising:
converting analog uplink transmissions for the message received at the two or more remote transceiver stations into digital signals;
encapsulating the digital signals into packets for transmission to the base station over a network.

11. The method of claim 10, wherein delaying comprises delaying the packets at the two or more remote transceiver stations with the corresponding time delays before sending the packets to the base station.

12. The method of claim 10, wherein delaying comprises delaying the packets at the base station with the corresponding time delays before further processing of the packets at the base station.

13. The method of claim 9, wherein determining comprises determining the reception time delays for the uplink transmissions that result in a decodable multipath solution for a receiver in the base station.

14. An apparatus comprising:
a network interface unit configured to communicate over a network;
a controller configured to be coupled to the network interface unit and to the receiver, wherein the controller is configured to:
generate a message to be transmitted via a plurality of remote transceiver stations deployed in a coverage area;
apply corresponding transmission time delays to the message for wireless transmission by corresponding ones of the plurality of remote transceiver stations; and
send the message to the plurality of remote transceiver stations over the network via the network interface unit for wireless transmission by corresponding ones of the plurality of remote transceiver stations with the corresponding time delays.

15. The apparatus of claim 14, wherein the controller is further configured to:
store data that assigns one or more remote transceiver stations to a cluster such that each remote transceiver station associated with the base station is a member of a single cluster;
store data that assigns different transmission time delays to each remote transceiver station in a corresponding cluster; and
store data that reuses the different transmission time delays among a plurality of clusters.

16. The apparatus of claim 14, wherein the controller is further configured to apply the corresponding transmission time delays by sending information comprising the transmission time delays to corresponding remote transceiver stations in order to assign a transmission time delay to a corresponding remote transceiver station such that each remote transceiver station delays transmission of the message based on its corresponding transmission time delay.

17. The apparatus of claim 14, wherein the controller is configured to apply the corresponding transmission time delays upon sending the message to the respective remote transceiver stations such that the message is received by the remote transceiver stations and wirelessly transmitted by the remote transceiver stations in accordance with the corresponding transmission time delays.

18. The apparatus of claim 14, wherein the controller is configured to apply the corresponding transmission time delays by adjusting a synchronization timestamp in the message that determines transmission time of the message from the respective remote transceiver stations.

19. The apparatus of claim 15, wherein the processor is configured to configured to apply corresponding transmission time delays by adjusting a synchronization timestamp for uplink packets that cause a corresponding processing delay at the receiver or delays uplink packet transmission time from a remote transceiver station.

20. The apparatus of claim 14, wherein the controller is further configured to:
determine reception time delays for a message received by corresponding remote transceiver stations from wireless mobile devices;
receive a message via the network interface unit that was wirelessly received at two or more remote transceiver stations from a wireless mobile device; and
delay processing of the message by corresponding reception time delays.

21. A system comprising:
a plurality of plurality of remote transceiver stations deployed in a coverage area and configured to be coupled to a network, each remote transceiver stations configured to:
wirelessly transmit signals to and receive signals from wireless mobile devices;
send and receive messages over the network;
a base station configured to be coupled to the network and configured to:
generate a message to be transmitted via the plurality of remote transceiver stations;
apply corresponding transmission time delays to the message for wireless transmission by corresponding ones of the plurality of remote transceiver stations; and
send the message to the plurality of remote transceiver stations over the network for wireless transmission by corresponding ones of the plurality of remote transceiver stations with the corresponding time delays.

22. The system of claim 21, wherein the base station is further configured to:
determine reception time delays for a message received by corresponding remote transceiver stations from wireless mobile devices;
receive a message via the network interface unit that was wirelessly received at two or more remote transceiver stations from a wireless mobile device; and
delay processing of the message by corresponding reception time delays.
